(19) United States
(12) Patent Application Publication
(10) Pub. No.: US 2002/0094510 A1
(43) Pub. Date: Jul. 18, 2002

(54) Article providing a support surface for a check

(76) Inventor: Joseph F. Alu JR., Wallington, NJ (US)

Correspondence Address: Mathews, Collins, Shepherd & Gould, P.A., Suite 306, 100 Thanet Circle, Princeton, NJ, 08540, US

(21) Appl. No.: 10/034,164

(22) Filed: Dec. 28, 2001

Related U.S. Application Data
(63) Continuation-in-part of application No. 09/378,254, filed on Aug. 20, 1999.

(51) Int. Cl. G09B 21/00

(52) U.S. Cl. 434/117

(57) ABSTRACT

The present invention relates to an article for providing a support surface for a check. The article is formed of a check pad comprising a rigid or semi-rigid material. The check pad has a width and a length corresponding to the shape of the check. Indicia can be applied to at least one surface of the check pad. A writing surface is included on the check pad.

This is a continuation-in-part of U.S. Ser. No. 09/378,254 filed Aug. 20, 1999.

### BACKGROUND OF THE INVENTION

1. Field of the Invention

The present invention relates to a laminated article for providing a support surface for a check and including indicia.

2. Description of Related Art

Writing guides have been used for holding writing and endorsing checks. U.S. Pat. No. 3,816,943 describes a writing guide for partially seeing, blind or muscularly disabled persons comprising a stiff backing element including means for holding a writing surface substantially immovable. A flexible flap is connected along one edge of the backing element. The flap is constructed to fold flat against the writing surface and includes one or more lengthwise creases which correspond to desired writing lines on the writing surface. The user folds back the flap along the crease conforming to the line on which he wishes to write for which the folded edge serves as a guide. Tactile and/or color contrasted markers adjacent each of the creases indicate the limits of the writing area. Disclosed embodiments include guides for writing and endorsing checks, filling out bank deposit and withdrawal slips, addressing envelopes and signing other types of legal documents.

U.S. Pat. No. 4,003,143 describes a multi-panel device for aiding check writing of a blind person. One panel is formed by a backplate which has a cavity over which an apertured template is inserted. The template overlying a check which is slipped into the cavity. The aperatures in the template position the writing on the check by the user of the guide. A second panel or base plate, hinged to the first panel acts as a stabilizing rest for the wrist area of the user.

U.S. Pat. No. 5,277,451 describes an information pad for checkbooks. The information pad is attached to a checkbook cover including a hinge member. The information pad is not used to provide support during execution of the check.

It is desirable to provide a support surface for a check which is useful with a conventional checkbook.

### SUMMARY OF THE INVENTION

The present invention relates to an article for providing a support surface for a check. The article is formed of a check pad comprising a rigid or semi-rigid material. A writing area is provided on the article. The article is laminated on both sides except in the writing area. Preferably, the check pad is formed of polycarbonate polypropylene or card stock. The check pad can have a thickness of about 0.005 inches to about 0.030 inches. The check pad has a width and a length corresponding to the shape of the check. Indicia can be applied to at least one surface of the check pad.

During use, the check pad is inserted in a conventional checkbook under a surface of a check. After use, the check pad can be carried in the checkbook or separately.

Other objects and features of the present invention will become apparent from the following detailed description considered in conjunction with the accompanying drawings. It is to be understood, however, that the drawings are designed solely for purposes of illustration and do not serve to limit the invention, for which reference should be made to the appended claims.

### BRIEF DESCRIPTION OF THE DRAWINGS

FIG. 1 is a perspective view of an article for providing a support surface for a check.

FIG. 2 is a perspective view of the article in combination with a conventional checkbook.

FIG. 3A is a perspective view of an embodiment of the article including indicia applied to a surface of the article.

FIG. 3B is an alternate embodiment of the indicia.

FIG. 4A is a flow diagram of a method of producing the article.

FIG. 4B is a perspective view of the article having the method of FIG. 4A.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

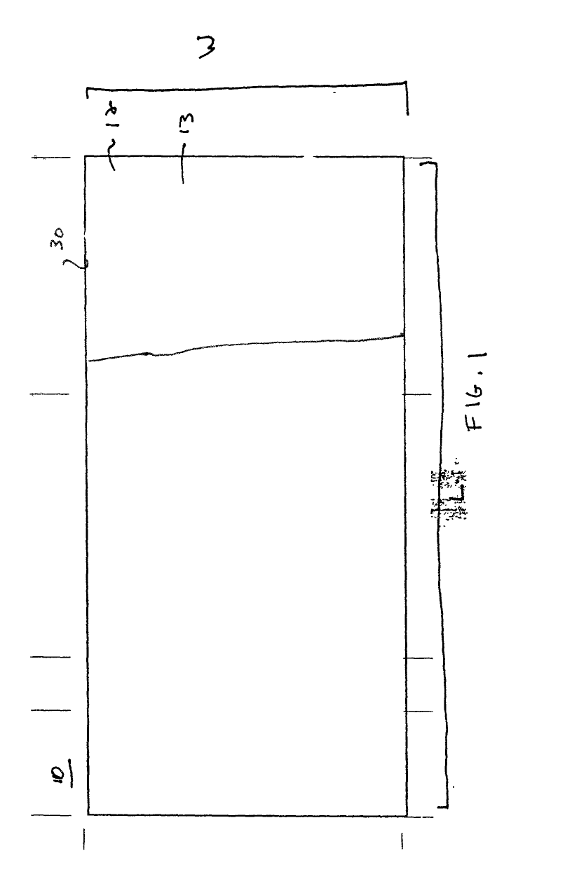

FIGS. 1-3 illustrate a schematic diagram of an article for providing a support surface for a check 10 in accordance with the teachings of the present invention. Article 10 comprises check support pad 12. Check support pad 12 is formed of material 13 which is a rigid or semi-rigid material to form a hard surface for supporting a check during execution thereof. For example, material 13 can be polycarbonate or polypropylene. Suitable polycarbonate materials are available commercially from McMaster-Carr, New Jersey. Alternatively, material 13 can be formed of card stock having a nominal thickness of about 0.005, 0.025 or 0.30. It will be appreciated that other conventional plastic or polymeric materials, which are known in the art, can be used as materials for forming the check support pad. Material 13 is formed or cut into length, L, and width, W, of conventional check sizes, such as 2¾ inches by 6 inches.

Portion 30 of material 13 is a writing area. Writing portion 30 can receive writing from an instrument housing HB lead or a softer lead by applying moderate hand pressure. Writing portion 30 is erasable for removing writing formed with the HB lead.

Material 13 can be laminated on front surface 23 and rear surface 24 with laminating material 11 except in writing portion 30. For example, laminating material 11 can be polyurethane or plastic. Laminating material 11 provides a glass or flat surface appearance.

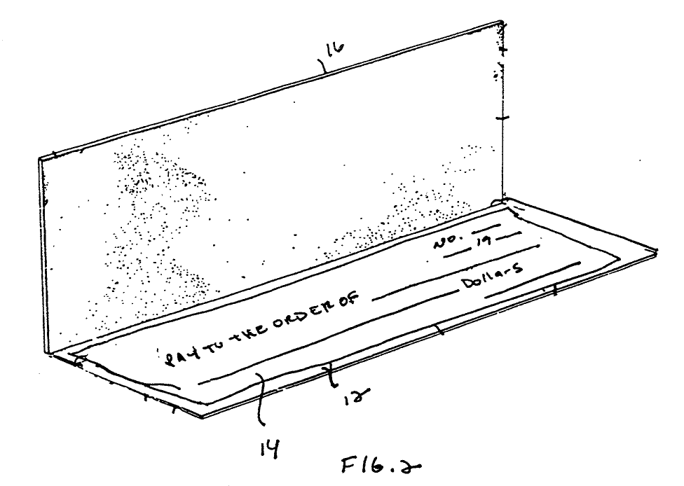

During use, check support pad 12 is placed under check 14 for providing stabilization and support of check 14 in checkbook 16, as shown in FIG. 2. It will be appreciated that check 14 can also include a conventional check and carbon. After use, check support pad 12 can be carried inside of checkbook 16 with checks 14 or separately such as in a purse or wallet. Checkbook 16 and check 14 are conventional and well known in the art.

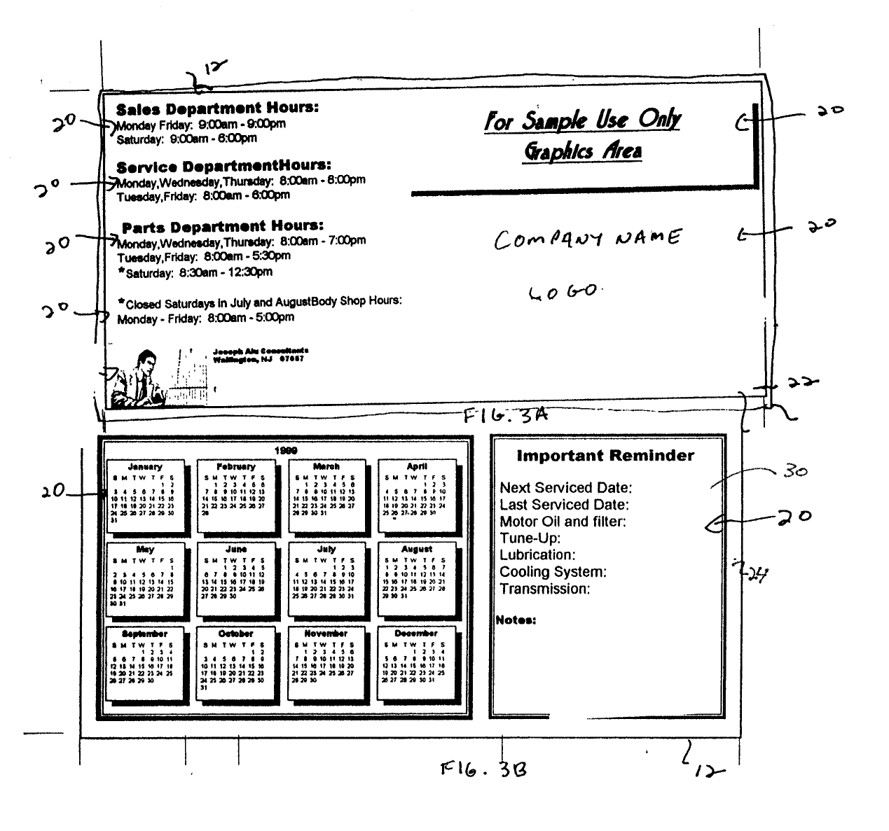

FIGS. 3A and 3B illustrate an embodiment of the check pad 12 including indicia 20 applied to at least one surface of check pad 12. For example, indicia 20 can include text indicia promotional advertising indicia such as company name indicia, service indicia or service department hours, personal identification indicia, such as name, home and address indicia, calendar indicia, flag indicia, graphical illustrations and photographs.

Check pad 12 can be customized according to needs of a customer's application. For example, indicia 20 applied to front surface 23 of check pad 12 can be an image or photograph of an American flag and text indicia. Indicia 20 applied to rear surface of check pad 12 can include text indicia such as history of the flag and writing portion 30. In an alternate embodiment, indicia 20 applied to front surface 23 of check pad 12 can include company advertising indicia arranged as a company's business card. Indicia 20 applied to rear surface of check pad 12 can include calendar indicia and text indicia of services provided for a customer such as a reminder for the customer's next visit or a maintenance record printed adjacent writing portion 30. In use, check pad 12 can be distributed to a company's customers for providing advertisement of the company's services. After use with checkbook 16, check pad 12 can be removed from checkbook 16 and displayed at a desk of a user or in a windshield of a vehicle.

Indicia 20 can be printed on label sheet 22. Label sheet 22 comprises a self-adhesive plastic or paper sheet. Label sheet 22 is cut or formed to have substantially the same size and shape as check pad 12. A backing of label sheet 22 is removed and label sheet 22 is adhered to check pad 12. Label sheet 22 can be applied to front surface 23 or rear surface 24 of check pad 12. Alternatively, indicia 20 can be printed directly to front surface 23 or rear surface 24 with conventional methods.

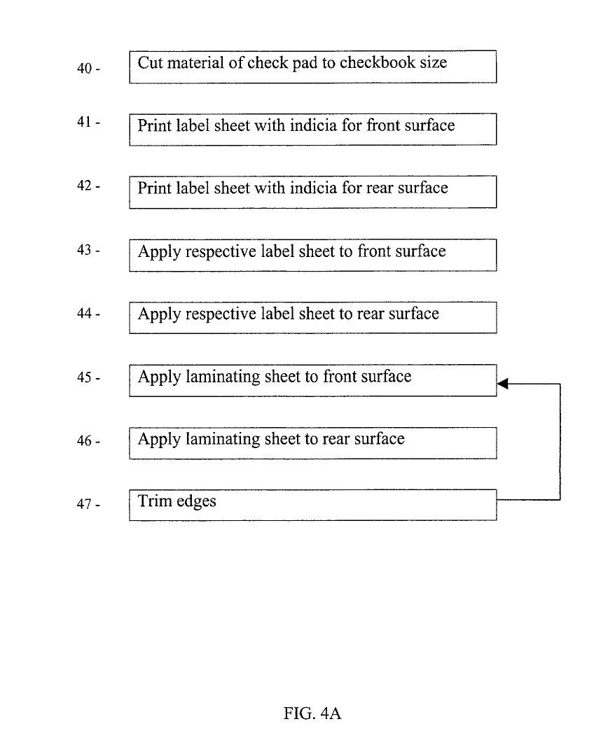

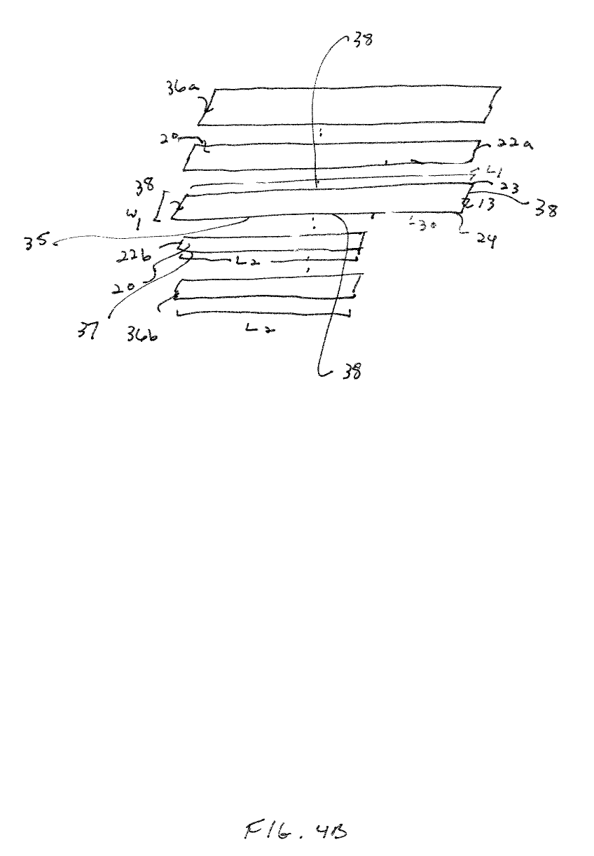

FIGS. 4A and 4B illustrate a process for forming check pad 12. In block 40, material 13 is cut to a length L₁ and width W₁ of a conventional check. Indicia 20 to be applied to front surface 23 of check pad 12 is printed on a first label sheet 22a, in block 41. For example, indicia 20 to be applied to front surface 23 comprises graphical illustrations, photographs or company advertising indicia. In block 42, indicia 20 to be applied to rear surface 24 of check pad 12 is printed on a second label sheet 22b. For example, indicia 20 to be applied to rear surface 24 comprises calendar indicia. Second label sheet 22b can have a length by which is the same or substantially less than the length L₁ of check pad 12. In block 43, label sheet 22a is applied to front surface 23 of check pad 12. In block 44, label sheet 22b is applied to portion 35 of rear surface 24 of check pad 12 or label sheet 22b can also be applied over writing portion 30. Laminating sheet 36a is applied to front surface 23 of check pad 12, in block 45. Laminating sheet 36b is applied to portion 37 of label sheet 22b extending over portion 35 of rear surface 24 of check pad 12, in block 46. Accordingly, laminating sheet 36b is not applied over writing portion 30. In block 47, edges 38 of check pad 12 are trimmed to provide a rugged dimension. Blocks 45-47 can be repeated to assure check pad 12 is sealed.

Check pad 12 formed of material 13 of polycarbonate is recyclable after treatment in a bath for removing applied label and laminated material.

It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

I claim:

1. An article for providing a support surface for a check comprising:
a check support pad, said check support pad being formed of a rigid material;
a writing portion formed on said check support pad, said writing portion adapted to receive writing;
indicia on at least one side of said check support pad, said indicia being selected from the group consisting of text indicia, promotional advertising indicia, personal information, calendar indicia, graphical illustrations, photograph and personal identification indicia;
said check support pad being laminated on a front and rear surface except in said writing portion,
wherein said check support pad is adapted to receive the check and the check support pad is sized to conform to the same dimensions as the check and said check support pad supports the check during execution thereof.

2. The article of claim 1 wherein said check support pad is formed of card stock, polycarbonate or polypropylene.

3. The article of claim 1 wherein said check support pad has a thickness in the range selected from the group consisting of about 0.005 inches; about 0.025 inches and about 0.030 inches.

4. The article of claim 1 wherein said indicia is printed on a sheet of self-adhesive plastic or paper, said sheet having the same size as said check support pad and said sheet is adhered to a surface of said check support pad.

5. The article of claim 4 wherein said sheet is adhered to said front surface and said rear surface of said check support pad.

6. The article of claim 1 wherein said indicia is printed on said check support pad.

7. The article of claim 1 wherein said writing portion is adapted to receive writing of HB lead from a writing instrument housing the HB lead.

8. The article of claim 1 wherein said indicia includes first said indicia of said photograph being a flag on said front surface of said check pad and second said indicia of said text indicia being history of said flag.

9. The article of claim 1 wherein said indicia includes first indicia of said promotional advertising indicia on said front surface of said check pad and second indicia of said calendar indicia.

10. The article of claim 9 further comprising third indicia of said third said promotional advertising indicia being related to services provided for a customer's said third being positioned adjacent said writing portion.

11. A method for forming an article for providing a support surface for a check comprising the steps of:
cutting a rigid or semi-rigid material into a width and length corresponding to a shape of a check;
printing a first label sheet with indicia for a front surface of said article;
printing a second label sheet with indicia for a rear surface of said article;
applying said first label sheet to said front surface;
applying said second label sheet to said rear surface; and
applying a laminating sheet to said front surface and said rear surface.

12. The method of claim 11 further comprising the step of:
trimming edges of said article in a rugged dimension;

13. The method of claim 1 wherein a writing portion is formed on said front surface or said rear surface of said article and said first label sheet, said second label sheet and said laminating sheet are not applied to said writing portion.

14. The method of claim 11 wherein said writing portion is adapted to receive writing of HB lead from a writing instrument housing the HB lead.

15. The method of claim 11 wherein said indicia being selected from the group consisting of text indicia, promotional advertising indicia, personal information, calendar indicia, graphical illustrations, photograph and personal identification indicia.

16. The method of claim 15 wherein said indicia includes first said indicia of said photograph being a flag on said front surface of said check pad and second said indicia of said text indicia being history of said flag.
